(19) United States
(12) Patent Application Publication
(10) Pub. No.: US 2010/0049583 A1
(43) Pub. Date: Feb. 25, 2010

(54) METHOD AND SYSTEM FOR SELECTION OF INFORMATION

(75) Inventor: Krishna Prasad Panje, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,477

(22) PCT Filed: Jun. 28, 2006
(86) PCT No.: PCT/IB2006/052166

§ 371 Date: Dec. 21, 2007

(30) Foreign Application Priority Data
Jun. 30, 2005 (EP) 05105894.9

(51) Int. Cl. G06Q 10/00; G06F 17/40; G06F 15/16

(52) U.S. Cl. 705/10; 707/104.1; 709/204; 707/E17.018; 707/E17.044

(57) ABSTRACT

Personal and/or group records of actions and events are kept, and statistical correlations between such actions and events are established. Actions undertaken by a user of an electronic device are monitored. If the statistical correlation between the first action that has been undertaken and a second action, e.g. a buying action, exceeds a threshold, information relating to the second action is selected and sent to the electronic device. The invention identifies and makes use of iamiliar paths leading to a second action and reacts to the undertaking of a first action preceding the second action by sending information to the user. Sending information is timed with the occurrence of an action which is a part of a path that is familiar to the user and leads to the second action.

### FIELD OF THE INVENTION

The invention relates to a method of selecting information to be sent to a user of an electronic device.

The invention also relates to a system for selecting information to be sent to a user of an electronic device.

### BACKGROUND OF THE INVENTION

It is known to select and send information, referred to as ‘push’ advertisements, to a user of an electronic device. Such ‘push’ advertisements are sent to the user in dependence upon the location. The location may be either a geographical location (the place where the device is situated) or a virtual location, e.g. a website. It is assumed that a person standing in front of a store or visiting a website would like to receive information on or relating to that store or website. However, the user is often not interested in the information sent to him and it is thus not much more than a waste of time and money for the provider of the information as well as for the recipient of said information. The information is also often sent to those that have already taken a decision, in which case it is at least annoying.

It is also known to make user profiles and to ‘push’ advertisements on the basis of such profiles. When profiling is used, typically a profile is composed and sent to an advertising agency. This advertising agency then sends advertisements to persons fitting the profile. The timing of such advertisements is, however, usually inconvenient or even worse. The recipient often considers the advertisement as an encroachment on his personal life at an inconvenient time. Instead of matching the information to the user's interests, irritation is generated.

### OBJECT AND SUMMARY OF THE INVENTION

It is an object of the invention to provide a method of selecting information to be sent to a user, for which the chances of matching the information to the recipient's interests are increased.

To this end, the method of selecting information to be sent to a user of an electronic device is characterized in that
actions undertaken by the user are monitored;
said actions are compared with historical or contemporary action records of location and time of one or more first actions preceding a second action of the user or of a group of users, wherein said records comprise information on statistical correlations between the preceding one or more first actions and the second action;
for one or more first actions that have been undertaken, the statistical correlation with the second action is compared with a threshold for either the user personally or for a group of users to which the user belongs, and
when the correlation exceeds a threshold, information relating to the second action and/or an intermediate action between the action undertaken and the second action is selected.

The system for selecting information to be sent to a user of an electronic device is characterized in that the system comprises:
a monitor for monitoring actions undertaken by the user;
a comparator for comparing said actions with historical or contemporary action records of location and time of one or more first actions preceding a second action of the user or of a group of users, wherein said records comprise information on statistical correlations between the preceding one or more first actions and the second action, and, for one or more first actions that have been undertaken, comparing the statistical correlation with the second action with a threshold for either the user personally or for a group of users to which the user belongs; and
a selector for selecting information relating to the second action and/or an intermediate action between the action undertaken and the second action when the correlation exceeds a threshold.

The records of location and time do not need to contain the location if it is implicit in the location where the records are stored. The records of location and time do not need to contain an absolute time, but it may be sufficient that an order between actions is stored. Monitoring actions undertaken by the user may comprise receiving actions monitored on another device. The selected information is preferably sent to the user of the electronic device. If the selected information is an instruction, it may be automatically performed by the electronic device. Automatically performing the instruction reduces the number of actions undertaken by a user to achieve his goal and can improve the speed at which a device or service can be navigated. The system may be, for example, an electronic device or may comprise a server and client software capable of running on an electronic device.

Statistical correlation is the correlation between the preceding action and the second action, e.g. a buying action, as seen from the preceding action, i.e. how often a preceding action or string of actions leads to or is followed by the second action. The threshold may be absolute, e.g. higher than in ×percent of the cases, or relative, e.g. ×times higher than the average for a larger group of persons. Relative correlations will highlight those familiar paths that are truly individual. It may also be both, i.e. the relative threshold as well as the absolute threshold is high. This highlights the truly individual paths which will be missed by any other method.

The invention is based on the recognition that human beings usually follow familiar paths which may be either personal paths or group paths. Humans are creatures of (personal and group) habits. Thus, there are often personal patterns of first actions preceding a second action. Humans also tend to follow the group. Thus, there are patterns of first actions leading to a second action for a group.

By keeping record of first actions leading to a second action, e.g. a buying action, such patterns can be statistically identified. By providing the user with information (advertisements) relating to the buying action when the likelihood that such a familiar path leading to a buying action has commenced, which likelihood is evident from the fact that the user has undertaken certain actions, the user is led via and to the familiar path to a position which is profitable for the seller.

The action record can be obtained by e.g. identifying the location of an action. The user's physical location is identifiable by means of various techniques such as A-GPS, EOTD, etc. with the aid of a mobile device carried by the user. The location in virtual space can be identified by the website the user is visiting. The action itself can be tracked electronically, because any action leaves an electronic trail. For activation actions (such as reservation of airline tickets), the time of reservation as well as the time for the reserved action, and thereby the intermediate period of time, are usually metadata for the transaction log.

All of these data can be stored in electronic data storage devices, and statistical pattern analyses may be performed on the data set.

The cell-phone service provider of the user or the shopping website may send the data on actions to a special portal. Alternatively, these actions may be derived by looking into the user's activity log. Alternatively, there may be a software module on the mobile device which monitors such events and sends the data to the portal. Analysis of the data may be done in situ, i.e. by a software module on e.g. a mobile device, or at the portal. For those embodiments in which activities of a group of persons, i.e. group action records, are analyzed, analysis is preferably done at a portal. For those embodiments in which personal action records are kept and analyzed, it may be preferred, for reasons of privacy protection, that the electronic device itself comprises a software module for monitoring and analyzing such actions.

By giving information on intermediate actions, the user is even more strongly guided on the familiar path. The information may only relate to the intermediate action or the intermediate action as well as the second action. In some circumstances, it may be advantageous to give information on the intermediate action only, rather than on the second action, because the user perceives this as less encroaching. He is only led to a position before the actual second action.

The invention prevents needless ‘push’ advertisements. The invention, when used for ‘push’ advertisements, results in much less irritation for the user, because he is in fact familiar with the situation, even if he does not react to the advertisement. The action suggested by the advertisement falls within the user's scope of expectations and he is much more likely to see it as a ‘friendly suggestion’ than as an encroachment on his personal life. The advertisement is well timed.

This type of selection for sending information is not to be confused with selection on the basis of a user profile. User profiles only give fixed information and do not allow dynamic response to actions or circumstances or to personalized information. When profiling is used, typically, a profile is composed and sent to an advertising agency. This advertising agency then sends advertisements to persons fitting the profile. The timing of such advertisements is, however, usually inconvenient or even worse. The recipient often considers the advertisement as an encroachment on his personal life at an inconvenient time.

In preferred embodiments, there is at least one first action between the action triggering the sending of information and the corresponding second action.

The sooner the information is sent, the better it is. The idea of the invention is to induce the user to follow the familiar path leading to the second action. Often, when the user undertakes an action immediately preceding a buying action, he has already taken the decision to buy, in which case sending the information may be helpful, but only to a small degree. The effect of the invention is greater when information is sent before the next-to-final step in a chain of actions leading to a second action.

Preferably, the monitored action is or comprises a reservation action, and an associated second action takes place in between the reservation action and the reserved action associated with the reservation action or immediately following the reserved action. Reservation actions (and associated reserved actions) are, for instance: buying an airline ticket (air travel), train ticket (train travel), reservation of seats for an opera (opera), and booking of a holiday (holiday).

Such reservation actions typically set into motion a string of actions in which users tend to follow a familiar path in the period of time between the reservation action and the reserved action. Such paths are often personal and can be recognized by analyzing historical personal action records.

Preferably, information relating to the second action and to an intermediate action is selected.

The invention is particularly advantageous when the reserved action and the second action take place at different locations. Actions that take place at different locations often (i.e. when they do not form part of a familiar string of events) have no or little relation to each other if they do not take place within the familiar string of events. In such a situation, the invention provides smart business opportunities that are not possible with other methods.

In embodiments, personal action records are kept.

In other embodiments, group action records are kept.

Group records may be restricted to a particular location and/or time.

Restricting group records to a particular place and/or time limits the extent of the records, which may seem to be a disadvantage. However, this is also an advantage because less data is to be analyzed and people tend to undertake similar strings of actions at the same location and time. Thus, knowledge of the ‘preceding group actions’ at a particular time, which leads to a second action, makes it possible to predict that a person of said group, when undertaking such a preceding action, might well be contemplating a second action, e.g. a buying action, (as the other members of the group did). It is effective to send him information at that time.

The invention is particularly useful when the electronic device is a mobile device. Mobile devices literally follow the user and consequently follow the user's path, including the ‘familiar’ paths leading to a second action. They are thus best suited for the collection of data on location and time of preceding actions.

### DESCRIPTION OF EMBODIMENTS

The invention will now be further described with reference to some examples.

### EXAMPLE 1

Consider, as a second action, a video-on-demand application downloading video from a digital library.

The sequence of actions and events is:
1. buying an airline ticket (reservation action),
2. driving to the airport,
3. browsing for new movies,
4. selecting an action movie (second action) to be rendered on the mobile device or on the car video player,
5. air flight (reserved action).

Suppose that a user has followed this sequence a few times (at least twice). This establishes a statistical correlation between buying of the airline ticket, on the one hand, and downloading of an action movie or at least of a movie, on the other hand. This is thus a path which is familiar to the user. The next time the user buys an airline ticket in accordance with the invention, the historical personal data base is checked on strings of actions, one element of which is buying an airline ticket, and another element appears to be frequently downloading a video movie.

This offers a business opportunity: within this string of actions, the user has already done the activity (buying an airline ticket) which is statistically correlated (for this person) with downloading of a movie. Thus sending him information leads to smart advertising, because there is a great probability that he will be interested in downloading a movie. It is to be noted that, in this example, the reservation action (buying an airline ticket) and the second action (downloading a movie) themselves (i.e. considered in general) are not logically related nor take place at the same location. Most people who buy an airline ticket do not download a movie to be rendered on a mobile device, and most people who download a movie do not plan on traveling by airplane. It is the method of the invention that makes the smart business opportunity available. In this example, the actions include a reservation action for a reserved action, wherein the second action takes place between the reservation and the reserved action. Reservation actions, i.e. actions that are logically succeeded by a reserved action at some time in the future, are particularly useful for the method according to the invention. They often start a string of events following a path which is familiar to the user.

### EXAMPLE 2

Consider, as a second action, eating in a restaurant.

The sequence of actions and events is:
1. reservation of theater seats,
2. taking a taxi to a restaurant,
3. eating in a restaurant (either before or after item 4),
4. theater (reserved action),
5. taking a taxi back home.

Personal and group records are kept. (In this case, a group is, for instance, the citizens of the town in which the theater is situated and/or the region around the city.) Those persons or groups of persons for whom this string of actions is statistically correlated above a threshold value are sent information on the possibility of ordering a taxi and/or making reservations of seats in a restaurant when seats for the theater are reserved. The threshold value may be either absolute, i.e. more than ×% of occasions, or relative, i.e. more than ×times (for instance, twice or three times) the overall average. Either way, the effect of pushing the advertisement is much larger than just sending it to anybody making a reservation. The use of a relative threshold value allows identification of truly personal familiar paths. This offers a new business opportunity: when the theater ticket is ordered, e.g. via a website or a mobile device, information is sent to the user on one or more restaurants near the theater.

At first glance, the above sequence of actions and events may seem quite ordinary. However, it is far from true that it would be useful to send such information to everybody who reserves seats in a theater. The overall statistical correlation between reservation of theater seats, on the one hand, and these activities, on the other hand, is at best unknown and probably (very) rare. For instance, many people come to the theater by other transportation means. Many go directly to the theater. Thus, sending information to everybody is most likely a waste of time and effort. In themselves, the actions of reserving seats in a restaurant, ordering a taxi and reservation of theater seats have no logical connection, for each action can be, and often is, undertaken independently of the other and at different locations. Even combining profiles is of only limited use. Searching for profiles of people who like to go to the theater and to a restaurant does not lead to finding those people who have the habit of eating in a restaurant before going to the theater. Furthermore, searching for these profiles will not allow timely sending of information on restaurants.

However, for those persons or groups of persons for whom this is a familiar path, as is apparent from the statistical correlation between the actions enumerated 1 to 5, it offers a smart business opportunity to provide them (and only them) with information. By keeping track of contemporary group records, certain groups of persons (for instance, persons living in a certain part of the region for a certain period of time) for whom the statistical correlation is relatively high may also be identified.

### EXAMPLE 3

Consider a beach on a hot summer day.

Consider the following actions and events:
1. driving to the beach (travel time),
2. time of day,
3. activating a mobile device,
4. checking the weather report on the activated mobile device.

Keeping track of this string of actions may reveal for a certain period of time (for instance, around 16.00 hrs, i.e. event 2) that there is a statistically relevant correlation between action 1 (the travel time), action 3 (activating the mobile device) and action 4 (checking the weather).

It then offers a business opportunity to ‘push’ advertisements on the weather report to a person who has activated the device (action 3) within the period of time. In this case, the comparison is made with a group record (namely the actions performed by the persons on the beach on that day) and an individual action (action 3).

### EXAMPLE 4

Consider the following actions and events:
1. booking a hotel room,
2. reservations for accommodation of pets,
3. hotel stay.

Keeping track of personal records will reveal that this is familiar string of actions and events for some persons. This offers a smart business opportunity: when hotel reservations are made, advertisement on accommodation for pets near the user's location are sent to the user. Again, although this may seem a rather logical string of actions and events, the predictive power of a hotel reservation (action 1) in itself for event 2 is generally very low. The predictive power may even be low for pet owners, because many pet owners take their pets with them or to relatives, or have their neighbors take care of the pets. However, for those for whom the statistical correlation between action 1 and event 2 is large, it offers a smart business opportunity to provide them with information on accommodation for pets. In this particular instance, it is most likely that such a ‘push’ advertisement will in fact be highly appreciated by the recipients, as it reminds them of an action which must be undertaken as soon as possible after booking so as to avoid problems later on.

The invention can be summarized as follows.

Personal and/or group records of actions and events are kept, and statistical correlations between such actions and events are established. Actions undertaken by a user of an electronic device are monitored. If the statistical correlation between the first action that has been undertaken and a second action, e.g. a buying action, exceeds a threshold, information relating to the second action is selected and sent to the electronic device. The invention identifies and makes use of familiar paths leading to a second action and reacts to the undertaking of a first action preceding the second action by sending information to the user. Sending information is timed with the occurrence of an action which is a part of a path that is familiar to the user and leads to the second action.

The user will find this much less encroaching than conventional ‘push’ advertisements and it increases the effectiveness of sending the information.

Sending the information may be performed in various ways.

A portal may send e.g. MMS advertisements related to advertisements on the second actions. Alternatively, a portal may ask a shopping website to take the responsibility of showing these advertisements to the user. When the actions are monitored by software inside the user's electronic device, e.g. a mobile device, the mobile device may send a trigger signal to a portal when the user has completed a number of actions sufficiently identifying that the user has started on a familiar path towards a second action. The portal then sends information on or related to the second action or an intermediate action. Alternatively, the cell-phone service provider may monitor the actions.

When the cell-phone service provider receives the user's actions indicating that he has completed a number of first actions sufficiently identifying that the user has started on a familiar path towards a second action, the cell-phone service provider sends a trigger signal to a portal. The portal then sends information on or related to the second action or an intermediate action. Alternatively, the cell-phone service provider may automatically send said information in said situation. In such an example, the software for monitoring actions and the statistical analysis of the actions is under the control of the cell-phone service provider.

In embodiments, the user may manually give the series of actions he has undertaken before the second action, or these actions may be automatically derived by looking into the user's activity log.

It will be appreciated by persons skilled in the art that the present invention is not limited by what has been particularly shown and described hereinbefore. The invention resides in each and every novel characteristic feature and each and every combination of characteristic features. Reference numerals in the claims do not limit their protective scope. Use of the verb “comprise” and its conjugations does not exclude the presence of elements or steps other than those stated in the claims. Use of the article “a” or “an” preceding an element or step does not exclude the presence of a plurality of such elements or steps.

The present invention has been described in terms of specific embodiments, which are illustrative of the invention and should not be construed as limiting. The invention may be implemented in hardware, firmware or software, or in a combination of them. Other embodiments are within the scope of the appending claims.

The invention is also embodied in any computer program comprising program code means for performing a method according to the invention when said program is run on a computer as well as in any computer program product comprising program code means stored on a computer-readable medium for performing a method according to the invention.

1. A method of selecting information to be sent to a user of an electronic device, wherein
actions undertaken by the user are monitored;
said actions are compared with historical or contemporary action records of location and time of one or more first actions preceding a second action of the user or of a group of users, wherein said records comprise information on statistical correlations between the preceding one or more first actions and the second action;
for one or more first actions that have been undertaken, the statistical correlation with the second action is compared with a threshold for either the user personally or for a group of users to which the user belongs, and
when the correlation exceeds a threshold, information relating to the second action and/or an intermediate action between the action undertaken and the second action is selected.

2. A method as claimed in claim 1, wherein group action records are kept.

3. A method as claimed in claim 2, wherein the group records are restricted to a particular geographical location and/or time span.

4. A method as claimed in claim 1, wherein personal action records are kept.

5. A method as claimed in claim 1, wherein information relating to the second action is selected.

6. A method as claimed in claim 1, wherein information relating to an intermediate action between the action undertaken and the second action is selected.

7. A method as claimed in claim 1, wherein there is at least one action between the monitored action triggering the selection of information and the corresponding second action.

8. A method as claimed in claim 1, wherein the monitored action is or comprises a reservation action and the associated second action takes place in between the reservation action and the reserved action associated with the reservation action or immediately following the reserved action.

9. A method as claimed in claim 1, wherein the electronic device is a mobile device.

10. A method as claimed in claim 1, wherein the threshold is an absolute threshold.

11. A method as claimed in claim 1, wherein the threshold is a relative threshold.

12. A method as claimed in claim 1, wherein the threshold is both absolute and relative.

13. A computer program comprising program code means for performing a method as claimed in claim 1 when said program is run on a computer.

14. A computer program product comprising program code means stored on a computer-readable medium for performing a method as claimed in claim 1.

15. A system for selecting information to be sent to a user of an electronic device, the system comprising:
a monitor for monitoring actions undertaken by the user;
a comparator for comparing said actions with historical or contemporary action records of location and time of one or more first actions preceding a second action of the user or of a group of users, wherein said records comprise information on statistical correlations between the preceding one or more first actions and the second action, and, for one or more first actions that have been undertaken, comparing the statistical correlation with the second action with a threshold for either the user personally or for a group of users to which the user belongs; and
a selector for selecting information relating to the second action and/or an intermediate action between the action undertaken and the second action when the correlation exceeds a threshold.
